(19) United States
(12) Patent Application Publication
(10) Pub. No.: US 2023/0287962 A1
(43) Pub. Date: Sep. 14, 2023

(54) TIGHTENER FOR CHAIN, STRAP, CABLE OR THE LIKE

(71) Applicant: WESTDEUTSCHER DRAHTSEIL-VERKAUF DOLEZYCH GMBH & CO.KG, Dortmund (DE)

(72) Inventor: Tim DOLEZYCH, Dortmund (DE)

(21) Appl. No.: 18/020,977

(22) PCT Filed: Aug. 13, 2021
(86) PCT No.: PCT/EP2021/072644

§ 371 Date: Feb. 13, 2023

(30) Foreign Application Priority Data
Aug. 26, 2020 (DE) 20 2020 104 941.0

(51) Int. Cl. F16G 11/12

(52) U.S. Cl. CPC F16G 11/12; B60P 7/083

(57) ABSTRACT

The invention relates to a tensioning device for tensioning chains (1), straps, ropes or similar tensioning means (1), comprising at least one tubular tensioning nut (2) and at least one threaded bolt (3) that is inserted into the tensioning nut (2) and is interacting with it, wherein the tensioning nut (2) and/or the threaded bolt (3) is/are equipped with a connection element (4) at the end, in particular for coupling to the tensioning means (1), and wherein the connection element (4) is movably connected to the tensioning nut (2) and/or the threaded bolt (3).

The invention relates to a tightener for a chain, strap, cable or similar tension element having at least one sleeve nut and at least one threaded bolt that is threaded into the sleeve nut, and the sleeve nut and/or the threaded bolt has an end connector, in particular for connection to the tension element.

Such tighteners are typically used in the field of lifting and shipping, that is to say in general logistics. The tension element to be clamped in this way is usually a chain, strap, cable or comparable tension element. With its aid, for example, cargo can be secured on transport surfaces of vehicles. Conceivable transport vehicles are trucks, trailers, semitrailers, etc. but also loading platforms of ships, containers etc.

Because of the fields of use described, high tightening forces must often be exerted on the tension element with the aid of the tightener. For this purpose, the tightener can, for example, be connected at one end to the tension element and can be fixed at its other end in or on the loading surface at a fastening point. However, it is also possible for the tightener to be connected at each end to a tension element in order to provide the necessary lashing force for securing the load on the transport surface in use.

Tighteners of the above-described construction are described for example in prior publications WO 2018/073098 [US 11,333,220] or also US 4,130,269. The known tighteners have proven successful if it is necessary, for example, to tension steel a chain as tension element and to apply to it the necessary tightening force.

In practice and increasingly, a so-called textile chain is used instead of a steel chain with forged chain links, as described in detail in applicant’s DE 20 2018 105 723 [US 2021/0356018]. In the case of such a textile chain as tension element, there is the problem that, when the sleeve nut is actuated with the aid of, for example, a ratchet, torques are applied to the tension element or textile chain. The consequence of these torques is that, on the one hand, a relatively large component of the tension applied by the tightener is lost as a result of the fact that the textile chain in question is twisted. This means that a reduced tension travel is available for the actual tightening process.

However, on the other hand, the fact that the torques introduced into the textile chain has the risk that, for example, a ratchet acting on the sleeve nut is still under torsional tension after the end of a tightening process due to the torques introduced into the textile chain. In the worst case, this can lead to injuries to an operator, and moreover damage due to spring back of ratchet is also possible. In addition to this non-return effect and the risk of injury to an operator, there is a further risk that, after the tightening process and, for example, release of ratchet, the previously introduced prestressing force is significantly reduced to a lower level.

Such problems do not occur or hardly occur in the case of a steel chain with forged chain links due to their reduced or not observed twistability Due to the increasing use of an advantageous textile chain in practice, however, the described problems arise in conjunction with the previous tighteners and increases the risk of injury. In this case, the invention seeks overall to provide a remedy.

The object of the invention is to further develop a tightener of this type for tensioning a chain, strap, cable or similar tension element in such a way that any torque in the tension element are controlled and in particular the risk of injury to an operator is reduced.

In order to attain this object, the invention proposes in a tightener of the generic type for tensioning a chain, strap, cable or the like in which the connector is movably connected to the sleeve nut and/or the threaded bolt.

The invention is based first on the fundamental knowledge that the tightener in question has at least one connector for connection to the tension element. The connector can in principle be provided and realized on the sleeve nut, the threaded bolt or both on the sleeve nut and the threaded bolt. This is due to the fact of a flexible arrangement of the tightener and flexible design of the tension element. For example, one end of the sleeve nut can be fixed to a transport surface while the bolt is threaded into other end of the sleeve nut.

If, by way of example, a textile chain is connected to this threaded bolt in a manner comparable to above-cited DE 20 2018 105 723 U1 of applicant, the threaded bolt can, for example, be equipped with the movable connector for connections to the tension element. Alternatively, the sleeve nut can also have such a connector. In any case, the movability of the connector for connection to the tension element overall leads to the fact that the tightener according to the invention expressly introduces no torque into the tension element during tightening. Rather, the movable design of the connector ensures that such torques are avoided from the outset.

Usually design is such that the connector is rotatably connected to the sleeve nut and/or the threaded bolt. In this case, the connector is generally designed to be rotatable about an axis running longitudinally. The axis in this case usually coincides with the axis of the sleeve nut and/or of the threaded bolt.

In addition, the design is moreover such that the connector is coupled with the sleeve nut and/or the threaded bolt with the interposition of a bearing. The bearing is usually mounted on the outer end of the sleeve nut and/or the threaded bolt. The bearing is usually a rotary bearing.

At this point, basically all conceivable variants of rotary bearings have been found to be favorable. In fact, the rotary bearing can be a ball bearing, a rolling bearing, a plain bearing, etc. individually or in combination. The connector may be designed, for example, as a connecting eye, but can also be designed as a connecting hook or combinations thereof.

In addition, at least one ratchet is connected to the sleeve nut in order to be able to introduce the required tightening force into the sleeve nut and consequently the threaded bolt. In addition to the ratchet mechanism, a fixing device is usually also provided. The fixing device may ensure that, when the ratchet is used, the sleeve nut is fixed with the aid of the fixing device, and consequently the required tightening force can be transmitted to the sleeve nut by the ratchet.

In this case, the fixing device can generally act on the threaded bolt and/or the sleeve nut. Usually, however, the sleeve nut is also equipped with the fixing device in addition to the ratchet, which can advantageously be a fixing lever. That is to say, in this case, the fixing device or the fixing lever does not engage the connector, but rather on the sleeve nut itself, specifically like the ratchet on its outer surface.

In any case, the fixing device or the fixing lever generally ensures that, during the tightening process, the sleeve nut is fixed during reversal of the ratchet. In fact, the tightening takes place with the aid of the sleeve nut and the ratchet in such a way that an extension as an example can be connected to the ratchet as a handle or tightening lever. When the sleeve nut is actuated, for example, for tensioning the tension element connected via the threaded bolt, the sleeve nut must be acted upon in an actuating direction, for example in a clockwise or counterclockwise direction. As a result, the threaded bolt can correspondingly increasingly screw into the sleeve nut. As a result, the connected tension element is correspondingly acted upon by the tightening force generated thereby.

In order now to exert the clockwise movement of the sleeve nut which has already been mentioned and described by way of example with the aid of the ratchet or the connected tightening lever on the sleeve nut, the tightening lever is moved, for example, from the first reversal point to the second reversal point into engagement with the sleeve nut. During the return movement of the tightening lever from the second reversal point to the first reversal point, on the other hand, the ratchet and consequently also the tightening lever are not in engagement with the sleeve nut. In order that the sleeve nut is now not moved back from the second reversal point during the return movement of the ratchet by, for example, frictional forces, the fixing device or the fixing lever at least at the second reversal point ensures that the sleeve nut is fixed in its rotated position. In addition, any torsional forces not present in any case according to the invention or can be avoided by the rotatable design of the connector.

As soon as the ratchet and with it the tightening lever has reached the first reversal point, the ratchet can again come into engagement with the sleeve nut at the first reversal point, so that, starting from this, the sleeve nut is further tensioned in the same actuating direction (clockwise in the example). As soon as the ratchet and with it the tightening lever have reached the first reversal point, the fixing device or the fixing lever is released so that the sleeve nut can be acted upon further in its actuating direction (clockwise in the illustrated embodiment).

The tightener can generally be equipped with two threaded bolts which dip into the sleeve nut and interact with it. That is to say, a design comparable to those in above-cited WO 2018/073098 A1 is conceivable here. In this case, the two threaded bolts engage in oppositely threaded ends of the sleeve nut and can in principle also engage in one another.

Usually, however, the tightener according to the invention is equipped only with a (single) threaded bolt that is threaded into the sleeve nut at its outer end. At its inner end, on the other hand, the end-side connector connected to the sleeve nut is realized. As a result, the tension element connected there can be loaded with the required tightening force with the aid of the one (single) threaded bolt. At the end of the sleeve nut and rotatably connected to the sleeve nut, at the same time, any torques in the tension element are avoided. This applies both to the case in which the end connector is fixed, for example, firmly on a loading surface, and when the end connector is also coupled to a further or the same tension element. That is to say, in the context of a particularly preferred variant, one not only is working with a (single) threaded bolt, but also in such a way that the connector is connected only to the sleeve nut, specifically to its end opposite the (single) threaded bolt. In principle, however, the connector can also only be connected to the sleeve nut or the threaded bolt.

As a result, a tightener is provided that prevents torque from being introduced from the outset and in principle into the tension element. As a result of this, the tension element can be loaded satisfactorily with the required tightening force, specifically without the tightening force resulting from the “turning back” of a tightening lever, as a rule, already provided and described above. Any injuries to an operator are thus expressly avoided. In addition, the tightener according to the invention is connected with the advantage that the introduced prestressing force is retained and does not fall to a lower level, for example, due to unwinding torsion. This is of particular importance for secure and permanent fixing of loads on a transport surface. The essential advantages are to be seen herein.

The invention is described in more detail below with reference to a drawing showing a single embodiment. Therein:

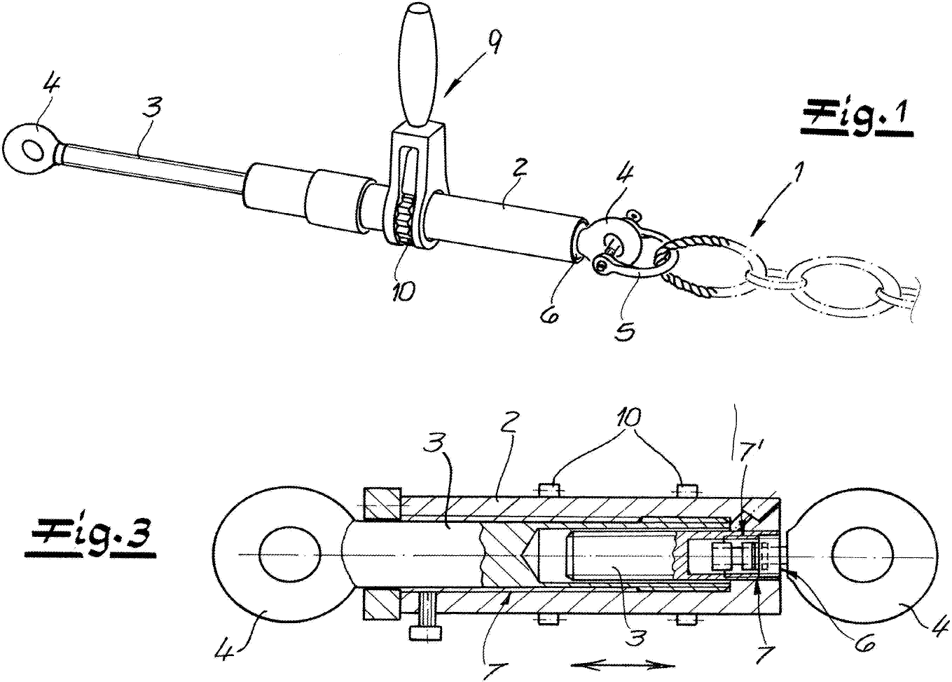

FIG. 1 is an overview of the tightener according to the invention,

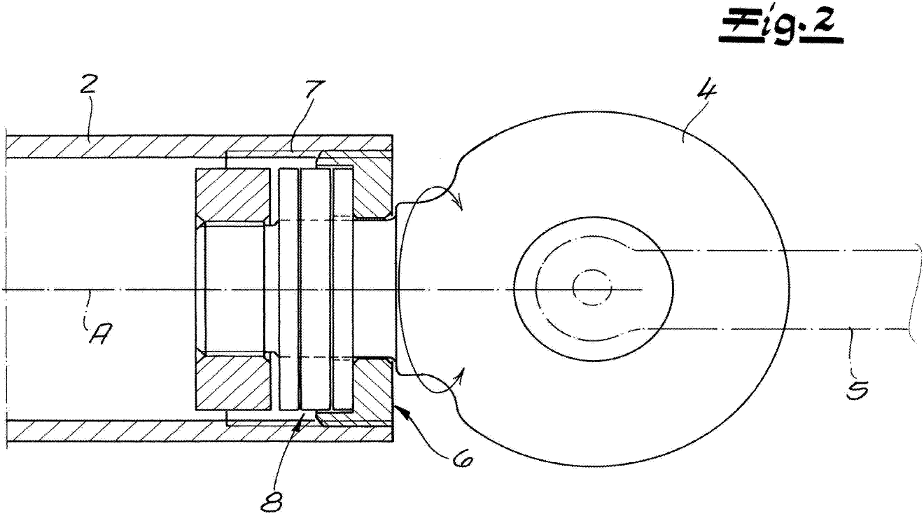

FIG. 2 is an enlarged detail view from FIG. 1 in the region of one of the connectors, and

FIG. 3 shows a modified variant of the tightener according to FIG. 1.

In the drawing, a tightener for a chain 1, strap, rope or similar tension element 1 is shown. In the illustrated embodiment, the tension element or chain 1 is a so-called textile chain as described in detail in the introductory part of applicant’s above-cited DE 20 201 8 105 723 U1. This means that the chain 1 or the textile chain 1 is composed of chain links, each of which is a ring made of a multistrand cable made of plastic filaments. The strands themselves are formed as multifilament yarns made of plastic fibers and are made from thermoplastic fibers, for example from PE, PA, PET, PP, etc.

The tightener shown in the overview of FIG. 1 for tensioning the textile chain 1 in the example has at least one sleeve nut 2. At least one threaded bolt 3 is threaded into the sleeve nut 2. In fact, the design is such that, according to the illustrated embodiment, the sleeve nut 2 interacts only with the one (single) threaded bolt 3 that engages into an outer end of the sleeve nut 2. In contrast, as illustrated this end is the left end of the sleeve nut 2. In contrast, the other outer end of the sleeve nut 2 (right in the illustrated embodiment) has an end connector 4. In the illustrated embodiment, the connector 4 is a connecting eye 4. However, the connector 4 can also be a connecting hook. In addition, the connector or connecting eye 4 is coupled to a shackle 5 shown in FIG. 1 to which in turn the textile chain 1 is connected in the illustrated embodiment. The threaded bolt 3 is also equipped with a connector 4, which is also a connecting eye 4 in the illustrated embodiment and is not limiting.

The special feature of the invention can now be seen in that the connector 4 is movably connected to the sleeve nut 2 and/or the threaded bolt 3. This means in principle that the invention makes it possible to design the connector 4 connected to the threaded bolt 3, the connector 4 connected to the sleeve nut 2, or both connectors 4 in a movable and in particular rotatable manner. In fact, in the context of the illustrated embodiment, the procedure is such that only the connector or connecting eye 4 connected at the end to the sleeve nut 2 is designed to be movable and rotatable, whereas the threaded bolt 3 has a connector or a connecting eye 4 that is fixed relative thereto or is fixed to the threaded bolt 3.

The rotation of the connector 4 is best seen on the basis of the enlarged illustration in FIG. 2. Here, it can be seen that the outer end of the sleeve nut 2 is coupled to the rotatable connector or tightening eye 4 in question. The tightening eye 4 can be rotated about an axis A that is also the axis A of the sleeve nut 2. This means that the axis A of rotation of the tension element 4 coincides with the axis A of the sleeve nut 2.

In this case, the design is made in detail in such a way that the connector 4 is rotatably received in a connection block 6. The connection block 6 is screwed into the outer end of the sleeve nut 2 into an internal thread 7 that is present in any case and is illustrated here. An external thread also interacts with the internal thread 7 at the other end of the sleeve nut 2. The connecting block 6 holds a bearing 8 or rotary bearing.

In the illustrated embodiment, the bearing or rotary bearing 8 is a ball bearing 8. In principle, it is also possible at this point to operate with a slide bearing, a plain bearing or even combinations. In any case, the rotary bearing 8 in the connection block 6 ensures that the connector or connecting eye 4 can rotate about the axis A of the sleeve nut 2, as indicated by a double-headed arrow in FIG. 2. As a result, in the case of a tightening process on the sleeve nut 2 no torque is applied to the textile chain 1.

In fact, the sleeve nut 2 carries ratchet mechanism 9, 10. The ratchet 9, 10 has not only a tightening lever 9 but also a toothed ring 10 fixed to the sleeve nut 2 as shown individually in FIG. 3. For this purpose, the ratchet mechanism 9, 10 has an additional tightening pawl, not explicitly shown that engages with teeth of the toothed ring 6, so that the sleeve nut 2 is regularly acted upon in a direction of rotation with the aid of the ratchet 9, 10, opposite rotation of the ratchet 9, 10 corresponds to the reverse movement or opposite movement, in which no rotational movement is exerted on the sleeve nut 2. In any case, the practically unilateral rotational movement with the aid of the ratchet 9, 10 on the sleeve nut 2 ensures that the threaded bolt 3 penetrates increasingly into the sleeve nut 2 and in the process exerts the desired tightening forces on the textile chain 1.

In addition to the ratchet 9, 10, it is also possible to provide an unillustrated fixing device that can act on the sleeve nut 2 or the connector 4 and thus the threaded bolt 3, as has already been described above. FIG. 3 shows a variant where two threaded bolts 3 are threaded into outer ends of the sleeve nut 2. Furthermore, the threaded bolts 3 are designed in such a way that the one threaded bolt 3 can also engage into a hollow bore of the other threaded bolt 3 in order to realize a particularly long adjustment travel of the tightener, as is described in detail in above-cited WO 2018/073098 A1. In addition, the design in this case is such that the two threaded bolts 3 engage in respective counter-rotating threaded sections 7 of the sleeve nut 2.

Within the scope of the illustrated embodiment, the procedure is such that the movable or rotatable connector 4 is only connected to the threaded bolt 3. For this purpose, the connection block 6 is screwed into an internal thread 7′ of the threaded bolt 3. In contrast, the opposite threaded bolt 3 has a fixed and non-rotatable connector or a corresponding connecting eyelet 4. In principle, it is also possible to proceed vice versa. Also, variants are conceivable in which both connectors 4 are each designed to be rotatable. This is not shown, however. In addition, a variant with only one rotatable connecting eye 4 with regard to handling is particularly advantageous, in which case the rotatable connecting eye 4 is connected to one end of the sleeve nut 2, as shown in FIG. 1.

1. A tightener for a chain, strap, cable or similar tension element, comprising at least one sleeve nut and at least one threaded bolt threaded into the sleeve nut, the sleeve nut and/or the threaded bolt having an end connector, in particular for connection to the tension element, wherein the connector is movably connected to the sleeve nut and/or the threaded bolt.

2. The tightener according to claim 1, wherein the connector is rotatably connected to the sleeve nut and/or the threaded bolt.

3. The tightener according to claim 1, wherein the connector is designed to be rotatable about an axis running in a longitudinal direction.

4. The tightener according to claim 3, wherein the axis coincides with an axis of the sleeve nut and/or of the threaded bolt.

5. The tightener according to claim 1, wherein the connector is coupled to the sleeve nut and/or the threaded bolt with the interposition of a bearing.

6. The tightener according to claim 5, wherein the bearing is mounted on an outer end of the sleeve nut and/or the threaded bolt.

7. The tightener according to claim 5, wherein the bearing is a rotary bearing.

8. The tightener according to claim 7, wherein the bearing is a ball bearing, rolling bearing, plain bearing, etc. individually or in combination.

9. The tightener according to claim 1, wherein the connector is a connecting eye.

10. The tightener according to claim 1, wherein at least one ratchet is connected to the sleeve nut.

11. The tightener according to claim 10, wherein a fixing device is provided in addition to the ratchet.

12. The tightener according to claim 11, wherein the fixing device engages on the threaded bolt and/or the sleeve nut.

13. The tightener according to claim 1, wherein there are two of the threaded bolts threaded into the sleeve nut.

14. The tightener according to claim 13, wherein the two threaded bolts engage in counter-rotating threaded sections of the sleeve nut.

15. The tightener according to claim 1, wherein the connector is movably connected either to the sleeve nut or to the threaded bolt.

16. A tightener for a tension element, the tightener comprising:
a sleeve extending along an axis, having two axially ends, and formed in one of the ends with an internal thread;
a bolt threaded into one of the ends;
a first connector fixed axially to the bolt;
a second connecter fixed axially to the other end of the sleeve; and
a rotary coupling between the bolt or the other end of the sleeve and the respective connector for free rotation about the axis of the respective connector relative to the other end of the sleeve or the bolt, whereby torque is not transmitted from the sleeve to the respective connector on rotation of the sleeve about the axis during tightening.

17. The tightener according to claim 16, wherein one such rotary coupling is provided for the both of the connectors.
